(19) United States
(12) Patent Application Publication
(10) Pub. No.: US 2025/0101751 A1
(43) Pub. Date: Mar. 27, 2025

(54) ADAPTABLE PEDESTAL ASSEMBLY AND SYSTEM FOR LEVELLING CONSTRUCTION SURFACES

(71) Applicant: MAXIMUS PEDESTAL SYSTEMS PTY LTD, Keilor East (AU)

(72) Inventors: Andrew RIVELLI, Airport West (AU); Philip RIVELLI, Keilor Downs (AU); Jack Joseph ALLWOOD, North Melbourne (AU); Kyle Murray Gordon JARRATT, North Melbourne (AU)

(21) Appl. No.: 18/679,918

(22) Filed: May 31, 2024

(30) Foreign Application Priority Data
Sep. 25, 2023 (AU) 2023903090

(51) Int. Cl. E04F 15/024; B66F 3/08; B66F 11/00

(52) U.S. Cl. CPC E04F 15/0247; B66F 3/08; B66F 11/00

(57) ABSTRACT

The present disclosure is directed to a pedestal assembly for levelling a construction surface and supporting at least one construction element. The pedestal assembly includes a pedestal assembly base, a pedestal assembly body that is operatively and releasably couplable to the base and includes one or more telescopic body members, each body member operably connectable or coupleable to another respective body member, a construction element support member having a non-planar levelling surface adapted for coupling to a complimentary non-planar engagement surface of at least one of the body members, a pedestal assembly locking component for fixing the position of the construction element support member with respect to the pedestal assembly body, and, a construction element spacer adapted to be accommodated by the support member for aligning one or more construction elements.

### RELATED APPLICATIONS

This application claims the priority of Australian Provisional Patent Application No. 2023903090 in the name of Maximus Pedestal Systems Pty Ltd, which was filed on 25 Sep. 2023, entitled “Adaptable Pedestal Assembly and System for Levelling Construction Surfaces” and the specification thereof is incorporated herein by reference in its entirety and for all purposes.

### FIELD OF INVENTION

The present invention relates to an adaptable pedestal assembly and system for elevating and/or levelling a construction or building surface (or element thereof) in which the pedestal is able to be modified for purpose. It will be convenient to hereinafter describe the invention in relation to an adjustable pedestal for supporting flooring elements such as, for example, tiles, however it should be appreciated that the present invention is not limited to that use, only. For example, the present invention will find application in use for external tiling and/or paving, balconies, landscaping, roof terraces and the like.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Height-adjustable pedestals are commonly used in building and construction for supporting surfaces like floors. For instance, such pedestals may be used by way of supporting flooring elements such as tiles, stones, joists or bearers, over uneven ground, or substrate surfaces. Typically, an array of pedestals may be deployed to provide an elevated surface across an uneven ground surface for the mounting of flooring elements.

There are various pedestal systems on the market that are used in building and construction to elevate external finish floors and/or to level uneven, sloped substrates upon which a building surface may be constructed. It is typical for these pedestals to be cylindrical and have their heights adjusted by relative movement of two parts, for example, through sliding engagement of the two parts or by relative rotation of screw threaded cylinders to increase or decrease the supporting height for the building element, e.g., floor tiles.

Conventional pedestals suffer a number of drawbacks. As noted, it is common that pedestals are designed to have two parts with a singular screw thread for adjustment. In this respect, most commonly a head portion with male screw thread operably connects with a base portion having female screw thread. Hence, when these two portions are unscrewed to increase the height of the pedestal, they can only adjust to a maximum height that is less than double the original total height of the individual portions. By way of example, the adjustable height range of three types of pedestals may be (a) 50-78 mm; (b) 77-108 mm and, (c) 100-175 mm, where for each of (a), (b) and (c), the first stated height is approximately that of an individual portion and the second stated height is that of the combined portions corresponding to a maximum adjustable height.

Stemming from above, multiple pedestal types may be required for a given installation. Furthermore, as the pedestal size range increases for different pedestal types, so does the cost. With that, the limited adjustment range means that when tiling or flooring an area where the substrate falls to a waste point (i.e., run-off or drainage point), the installer may often require multiple sized pedestals to accommodate the slope. Where multiple pedestal sizes are required, it becomes difficult, if not impossible, to accurately estimate the cost of the area in construction until installed.

With a given pedestal, when its maximum height is reached but the required supporting height is not reached, the installer will often use foreign objects, such as off cut tiles, timber, or packers to achieve the final height required. Using foreign objects in this way causes the pedestal system to be unstable and furthermore, can compromise any waterproof membranes between the pedestal and the ground or substrate surface.

The larger size types of pedestals have the drawback that fewer of these pedestals can be fitted into a carton and they take up more warehouse stock space than their smaller counterpart type pedestals. Furthermore, by their nature, existing pedestal assemblies are pre-stocked or warehoused before deployed only in their component parts to be assembled only on site once the requirements of construction work can be identified.

Another problem with existing pedestals is that the fixed head of a pedestal means the head cannot pivot. Accordingly, the disposition of the supporting surface provided by the pedestal cannot be easily adjusted. The result is that additional parts are required to allow for such as the fall to a waste point in a substrate or ground surface. Pivoting head pedestals are available for this and can compensate for ground/substrate falls. However, adjustment of the pivoting head requires the use of a tool as does the adjustment of the height.

Examples of known pedestal systems are set out as follows.

The Impertek™ Balance Pro™ “all in one” self-levelling system is described at www.impertek.com under a pedestal product line page of that website. This pedestal system has an advantage in that a fix ring allows for a pivoting head to become fixed but it also has a disadvantage in that, when in pivoting position, a tool is required to adjust the pedestal. Furthermore, multiple size pedestals are required for use on uneven substrates. By way of explanation, the Balance Pro™ system allows a top plate of the pedestal to rotate about horizontal axes (i.e., to tilt away from the horizontal) with respect to the shaft. In this way, flooring members can be supported at a non-zero angle to the base. Adjustment of the pedestal height is facilitated only via a tool which penetrates the top plate to rotate the upper threaded member relative to the lower threaded member.

Eterno Ivica S.r.l. supply an adjustable pedestal, the “Eterno SE” pedestal which is disclosed at www.pedestal-eternoivica.com under a product page describing adjustable pedestals. This product has a ‘bi-component’ head for self-; levelling. Again, it requires the use of a tool for adjustment and, multiple size pedestals are required for use on uneven substrates.

Profilpas spa. provide the PP Level Duo™ support for raised floors, which is disclosed at www.profilpas.com on the ‘find product’ page of that website. A fix ring allows for selection between fixed and self-levelling functions, which again requires a tool. Further, multiple size pedestals are required for use on uneven substrates.

Hangzhou Moonbay Industrial Co., Ltd. provide a Moonbay™ adjustable paving pedestal, which is disclosed on the product line page of www.moonbayjack.com. A base slope corrector is included to place underneath the pedestal for adjusting for the level of a substrate surface. This solution requires multiple size pedestals for use on uneven substrates.

Buzon Pedestal International S.A. provide an adjustable pedestal that also includes a base slope corrector to place underneath the pedestal for adjusting for the level of a substrate surface. This product only has a fixed head and, again, requires multiple size pedestals for use on uneven substrates. Further published patent disclosures of Buzon Pedestal International S.A. are discussed, below.

Another example of fixed head and multiple sized pedestals for use on surfaces is found at www.karaoapp.com.

Canadian patent publication No. 2966091 in the name of Repasky discloses a stabilizing system for a deck system including a plurality of pedestals, a plurality of connection locations on a periphery of the pedestals and at least one stabilizing member secured between the pedestals. Each of the pedestals supports corner portions of adjacent blocks, pavers or panels a spaced distance above an underlying structure extending generally parallel to the blocks, pavers, or panels. The plurality of connection locations on a periphery of the pedestals are located both proximate the supported corner portions and proximate the underlying structure. This system requires at least one stabilizing member in the form of a stabilizing bar, elongate wires, wire rope, cable or rods secured to and extending between the connection locations of at least two of the pedestals.

A height and slope adjustable pedestal is disclosed in U.S. Pat. No. 9,803,377 (Pelc, Jr. et al.) assigned to the Ipe Clip Fastener Company LLC. An elevating leveling pedestal is disclosed having a base rotatably attached to a first coupling end to collectively create a height adjustment mechanism, and further includes a second coupling end non-rotatably attached to a first end of a non-threaded midsection of predetermined length with a second end non-rotatably attached to a head assembly to support, secure, and level a surface installed over a non-sloping or sloping sub-surface. Another embodiment is disclosed comprising a height and slope adjustable pedestal that has its tilting mechanism on the bottom of the pedestal allowing the pedestal column to remain vertical and not skewed and is made using a single length of unthreaded piping, the rotatable device base having minimal surface threading, and the device base able to be locked in a zero or non-zero slope for supporting a structure above a fixed surface. Also disclosed is a method of using such a device. When installation is on a sloped surface, a zero compensator washer is removed, the head tilted to the required slope, and then locked into that position using a locking washer. The head is locked into position from the top side by using a center tightening bolt that is tightened into a double-ended, multi-purpose bushing bolt mechanism. A tightening bolt fastener secures the multi-purpose bushing in place at the desired slope and also further secures deck-tiles to the head.

Canadian patent publication No. 2838374 (United Construction Products LLC) discloses a pedestal system with concealed tile restraint on an adjustable rail brace positioned between pedestals. A support structure for elevating a building surface above a fixed surface is disclosed including a plurality of support pedestals disposed in spaced-apart relation on the fixed surface, a plurality of stabilizing braces interconnects adjacent support pedestals, and a plurality of restraint members. The restraint members include a mounting portion securable to one of the plurality of stabilizing braces and a restraint portion operatively attached to the mounting portion and securable to an outer edge segment of one or more of the surface tiles.

U.S. Pat. No. 10,415,191 (Tabibnia) discloses a planting system having a plurality of potting trays that can be interconnected in a modular fashion to create a multitude of different configurations. A plurality of pedestals may be used to elevate the planting system. Lateral braces may be used to interconnect the plurality of pedestals.

Australian patent application no. AU-A 2022201156 (Buzon Pedestal International S.A.) discloses a support element for spacers comprising a base provided for being placed on a surface elevation pedestal. The base is provided with at least a first and a second window having a curved geometry, each window being provided for applying therein one of the spacers in such a manner that the spacer can be freely moved in the window in which it is applied and be guided by that window when being moved, the first and second window each having a start section and a final section, the final section of the first window and the start section of the second window being juxtaposed one to each other in such a manner that a linear axis starting from a centre of the basis in a direction towards an external border of the basis crosses successively the final section of the first window and the start section of the second window.

International patent application publication No. WO 2023/062083 (Ryno Ltd) discloses a self-levelling pedestal (100) for supporting a flooring member. It has a top plate pivotable relative to the floor such that it can be oriented at a non-zero angle to the floor. A locking mechanism is provided which is configured to lock the position of the top plate in at least one non-zero angle.

Granted Australian patent No. AU-B 2016269395 (Buzon Pedestal International S.A.) discloses a device for compensating a slope of a construction surface and which is adapted for placing on or under a pedestal. The surface slope compensation device comprises a first and a second slope compensation element, each having the shape of a disc and cooperating with each other for compensating the slope. The first and second slope compensation elements are mounted in such a manner as to be able to rotate with respect to each other. This solution has a drawback in that the adjustment angle needs to be known prior to installation, otherwise, if the incorrect angle is selected, it may only be identified upon installation. On detecting such a mistake, the system needs to be disassembled to adjust the slope compensation angle.

Granted Australian patent No. AU-B 2021101806 (Elmich Pte Ltd) discloses a height extension element for a pedestal. A top extender for a pedestal jack includes a top surface which is configured to receive accessories such as slope correctors and includes a series of cylindrical apertures, and an underside which defines a series of depending cylindrical plugs/spigots which locate in corresponding holes in the top of the pedestal jack. The top extender does not require the top of the pedestal to be removed for fitting and the spigots simply slot into the top of the pedestal. The top extenders can be stacked together for transportation with the spigots removably locating in the apertures in the top surface.

Australian Innovation US2010100928 (Lee) discloses an adjustable pedestal component having four arcuate support blocks forming ramps. In use, two components are utilised with one component inverted and superimposed on the other such that turning an upper component relative to the other raises the height of the pedestal.

Granted Korean patent publication No. KR 100772555 discloses a height adjustable screw type pedestal. Height is adjusted by screwing a support device and a second expansion device with a first expansion device. The height adjustable screw type pedestal for construction comprises a support device, an expansion ring, a sustaining device, and a split tap. The expansion ring is divided into a first expansion ring and a second expansion ring. A first screw part of the first expansion ring is coupled with a second screw part of the support device. A third screw part of the first expansion ring is coupled with a fourth part of the second expansion ring. A fifth screw part is coupled with a sixth screw part. The height of the upper surface from the lower surface of the support device to the sustaining device is varied according to the rotary direction of the support device, the first expansion ring, the sustaining device, and the second expansion ring. A holding part is extended to the front end of the second expansion ring to form the fifth screw part in the holding part.

The preceding discussion of background art is intended to facilitate an understanding of the present invention only. The discussion is not an acknowledgement or admission that any of the material referred to is or was part of the common general knowledge as at the priority date of the application.

### SUMMARY OF INVENTION

It is an object of the embodiments described herein to overcome or alleviate at least one of the above noted drawbacks of related art or prior art systems or to at least provide a useful alternative to related and prior art systems.

In one aspect of embodiments, the present invention provides a pedestal assembly adapted to level a construction surface and support at least one construction element. In other aspects of embodiments, the present invention provides a system and method for levelling a construction surface and supporting at least one construction element.

Generally, the present invention provides a system for levelling a construction surface and supporting at least one construction element, the system comprising at least one pedestal assembly comprising:
a base for supporting the pedestal assembly on a substrate surface;
a body comprising a plurality of operably connected telescopic members, the body operatively and releasably coupled to the base;
a support member for supporting the at least one construction element, wherein the support member comprises a levelling surface adapted for coupling with a corresponding complimentary engagement surface of a first of the plurality of telescopic members of the body so that a tilt angle of the support member is adjusted by pivoting the support member with respect to the body;
a locking component adapted to be placed within a commonly aligned aperture of at least the support member and the first of the plurality of telescopic members, the locking component configured to fix the position of the support member with respect to the body;
a spacer adapted to be accommodated by the support member for aligning one or more construction elements;
wherein adjustment of the height of the pedestal assembly is facilitated by one or a combination of:
manual movement of the support member;
manual movement of at least one of a second or third telescopic member of the body, and;
tool engagement with a drive arrangement of the first telescopic member of the body accessible via a commonly aligned aperture of the first telescopic member of the body, the support member, the locking component and the spacer.

Preferably, the levelling surface of the support member and the complimentary engagement surface of the first telescopic member are non-planar or curved.

Preferably, each of the base, the plurality of operably connected telescopic members and the support member are operatively coupled to each other for adjusting the height of the pedestal assembly by relative rotational movement.

Preferably, the locking component is configured to fix the position of the support member to be parallel with the base.

Preferably, the manual movement of the support member and at least one of a second or third telescopic member of the body for adjusting the height of the pedestal assembly is rotational movement.

Preferably, the rotational movement is assisted by one or a combination of:
screw threaded configuration of the telescopic members;
the second or third telescopic members having lugs for assisting hand or finger engagement by a user, and;
peripheral aperture formations of a support plate of the support member that provide notches for assisting hand or finger engagement by a user.

Preferably, the base comprises a housing and a base plate that are releasably connectable for insertion of height extenders.

Preferably, the drive arrangement of the first telescopic member is a mesh drive.

Generally, the present invention also provides a pedestal assembly for levelling a construction surface and supporting at least one construction element, the pedestal assembly comprising:
a base for supporting the pedestal assembly on a substrate surface;
a body comprising a plurality of operably connected telescopic members, the body operatively and releasably coupled to the base;
a support member for supporting the at least one construction element, wherein the support member comprises a levelling surface adapted for coupling with a corresponding complimentary engagement surface of a first of the plurality of telescopic members of the body so that a tilt angle of the support member is adjusted by pivoting the support member with respect to the body;
a locking component adapted to be placed within a commonly aligned aperture of at least the support member and the first of the plurality of telescopic members, the locking component configured to fix the position of the support member with respect to the body;
a spacer adapted to be accommodated by the support member for aligning one or more construction elements;
wherein adjustment of the height of the pedestal assembly is facilitated by one or a combination of:
manual movement of the support member;
manual movement of at least one of a second or third telescopic member of the body, and;
tool engagement with a drive arrangement of the first telescopic member of the body accessible via a commonly aligned aperture of the first telescopic member of the body, the support member, the locking component and the spacer.

Generally, the present invention also provides a kit of parts for a pedestal assembly for levelling a construction surface and supporting at least one construction element, the kit of parts comprising:
a pedestal assembly base;
a pedestal assembly body that is operatively and releasably couplable to the base and comprises one or more telescopic body members, each body member operably connectable or coupleable to another respective body member;
a construction element support member having a non-planar levelling surface adapted for coupling to a complimentary non-planar engagement surface of at least one of the body members;
a pedestal assembly locking component for fixing the position of the construction element support member with respect to the pedestal assembly body; and,
a construction element spacer adapted to be accommodated by the support member for aligning one or more construction elements.

Other aspects and preferred forms are disclosed in the specification and/or defined in the appended claims, forming a part of the description of the invention.

In essence, embodiments of the present invention stem from the realization that emulating a ball and socket joint between the support member and a first telescopic member of the pedestal assembly allows for ready adjustment of the tilt angle of a supporting surface for construction elements and also for the provision of a commonly aligned aperture through components of the pedestal assembly which provides for in situ access of a tool for height adjustment. With that, spaced engagement of the levelling and engagement surfaces of the support member and first telescopic member, respectively, with protrusions accommodated in oversized apertures gives a desired range of tilt angles to a support member and, adapting pedestal components for rotational movement with notched edges or circumferences allows for easy manual adjustment of the pedestal.

Advantages provided by the present invention comprise the following:
The multiple telescoping screw thread design of the adaptable pedestal provides a significantly larger range of height adjustment in the one pedestal. Hence it replaces a requirement for using multiple different pedestal sizes with the one pedestal;
A single adjustable size pedestal reduces wastage and dead stock space and, therefore also cost in both manufacture and use by installers;
With the height adjustment range being significantly increased, the need for installers to use foreign objects to compensate for a lack of height will be obviated;
The base of the pedestal of the present invention is removable, which allows for the insertion of extenders to provide increased height to the pedestal;
Specialised tools are not required to adjust the pedestal of the present invention;
A high speed chuck and/or maintenance key allows for an increased speed of adjustment of the pedestal of the present invention. In this respect, a high speed chuck is operable with a drill for fast screwing/unscrewing of the pedestal and, a maintenance key is insertable into the head of the pedestal for adjusting the pedestal post installation without need for removing floor components, e.g., tiles;
The pedestal head can be readily switched from fixed to pivotable through the operation of a locking nut;
In either fixed or pivoting operation, the pedestal of the present invention may be adjusted by hand, with a high speed chuck and/or with a maintenance key.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 is a top perspective view of a height adjustable pedestal assembly adapted for levelling construction surfaces and showing the assembly in an extended configuration in accordance with a preferred embodiment of the invention;

FIG. 2 is a side view of the pedestal assembly of FIG. 1 showing the assembly in a retracted configuration;

FIG. 3 is a side view of the pedestal assembly of FIG. 1 showing the assembly in an extended configuration;

FIG. 4 is an exploded side view of the pedestal assembly of FIG. 1 and showing a locking component in accordance with an embodiment of the invention;

FIG. 5 is a top perspective view of the pedestal assembly of FIG. 1 showing the assembly in a retracted configuration;

FIG. 6 is a top plan view of the pedestal assembly of FIG. 1;

FIG. 7 is a bottom plan view of the pedestal assembly of FIG. 1;

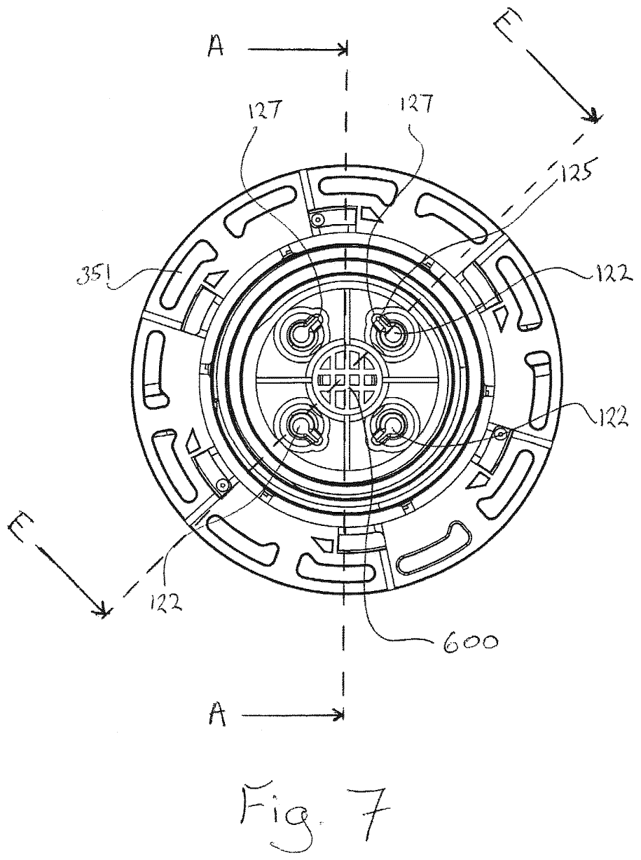

FIG. 8 is a top perspective view of a base plate portion of the base of the pedestal assembly of FIG. 1;

FIG. 9 is a top perspective view of a housing portion of the base of the pedestal assembly of FIG. 1;

FIG. 10 is a top perspective view of a third telescopic member of a body portion of the pedestal assembly of FIG. 1;

FIG. 11 is a top perspective view of a second telescopic member of a body portion of the pedestal assembly of FIG. 1;

FIG. 12 is a top perspective view of a first telescopic member of a body portion of the pedestal assembly of FIG. 1 showing an engagement surface which is used for levelling construction surfaces in accordance with an embodiment of the invention;

FIG. 13 is a top perspective view of a support member of the pedestal assembly of FIG. 1 which is used for levelling construction surfaces in accordance with a preferred embodiment of the invention;

FIG. 14 is a bottom perspective view of the support member of FIG. 13 showing a levelling surface which is used for levelling construction surfaces in accordance with a preferred embodiment of the invention;

FIG. 15 is a top perspective view of a locking element of the pedestal assembly of FIG. 1;

FIG. 16 is a top perspective view of a spacer element of the pedestal assembly of FIG. 1;

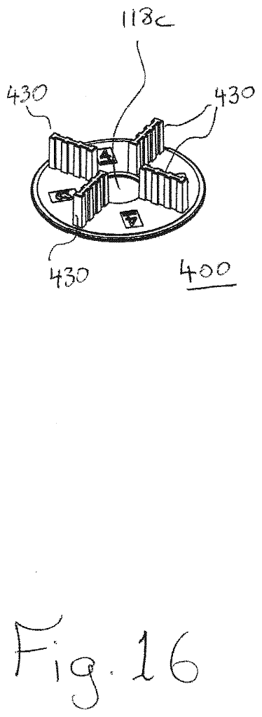

FIG. 17 is a side sectional view of an upper portion of the pedestal assembly as shown in FIG. 7, cut along the A-A plane;

FIG. 18 is a side sectional view of an upper portion of the pedestal assembly as shown in FIG. 4, cut along the B-B plane;

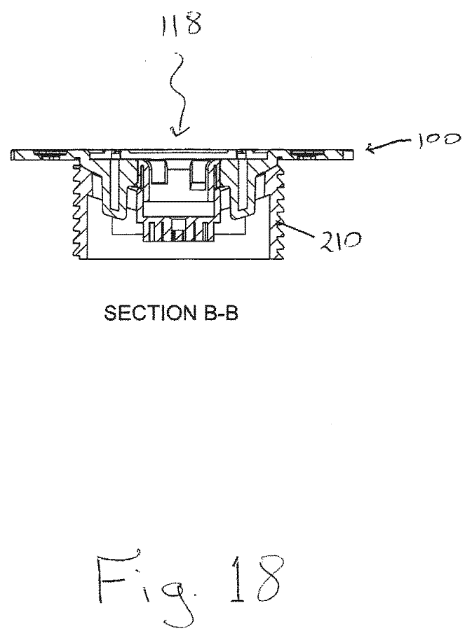

FIG. 19 is a side sectional view of an upper portion of the pedestal assembly as shown in FIG. 7, cut along the E-E plane;

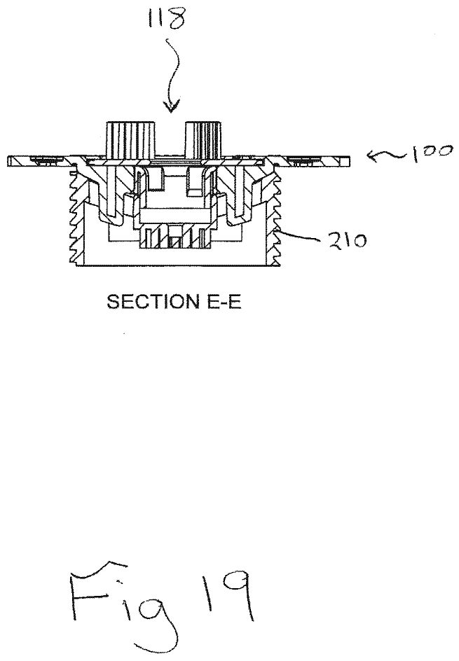

### DETAILED DESCRIPTION

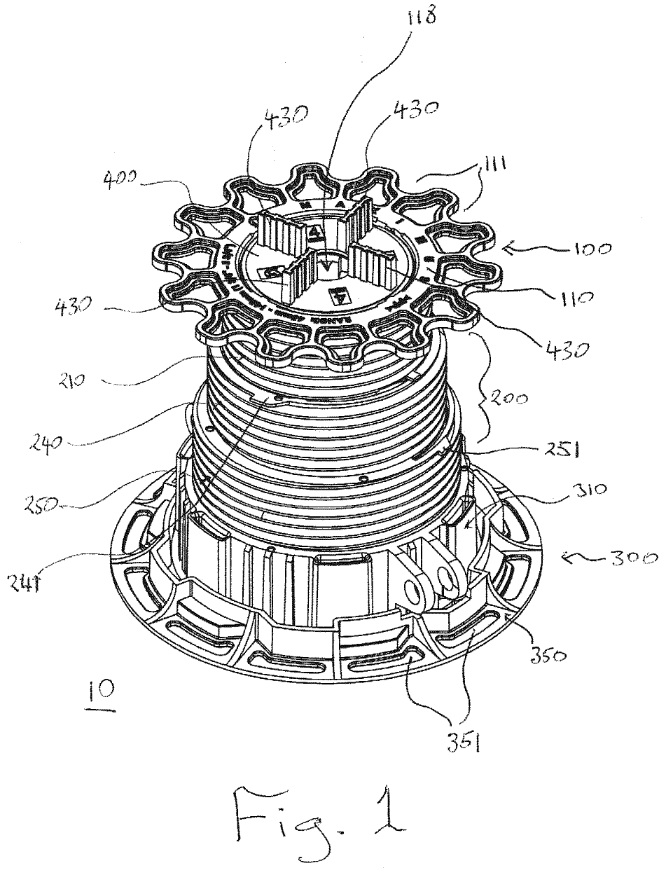

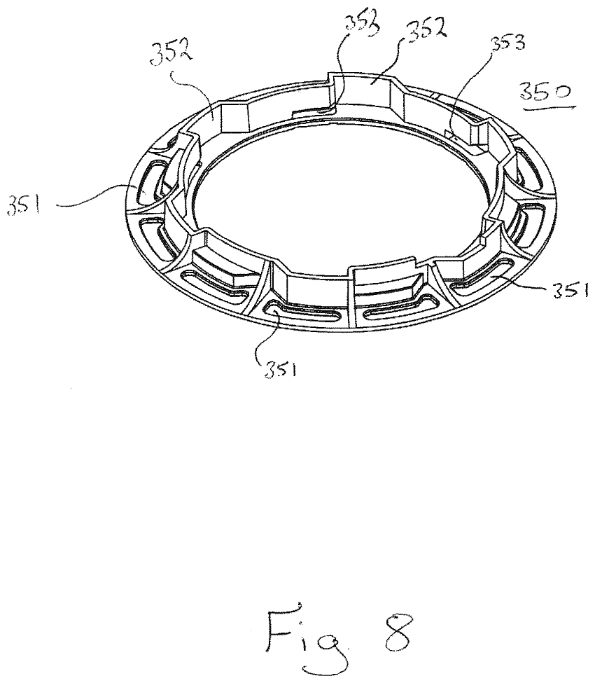

FIG. 1 shows a height adjustable pedestal assembly 10 adapted for levelling construction surfaces having a support member 100 for supporting at least one construction element (not shown), in particular, flooring elements such as timber joist or stone tiles may be supported. The assembly includes a base 300 with a tubular housing 310 and a base plate 350 for securing the pedestal assembly 10 to a floor or substrate surface. In respect of securing the pedestal assembly to a floor or substrate surface, this means the base plate 350 supports the pedestal assembly 10 as it is placed upon a floor or substrate surface without necessarily fixing or anchoring the base plate 350 to the floor. However, drainage apertures 351, as best shown in FIG. 8 showing the base plate 350 in isolation, are located within and around the periphery of the base plate 350. These primarily serve the purpose of allowing egress of fluids and drainage from the pedestal assembly. Additionally, these apertures 351 provide for minimising material in manufacture of the pedestal assembly 10 but may also serve as anchoring points to fixedly secure the pedestal assembly 10 to a floor or substrate surface.

The assembly also includes a body 200 operatively and releasably coupled to the support member 100 and the base 300. The body 200 is provided with up to three or more telescopic members in the form of concentrically arranged tubular members shown in the accompanying drawings as first, second and third telescopic members 210, 240 and 250, respectively.

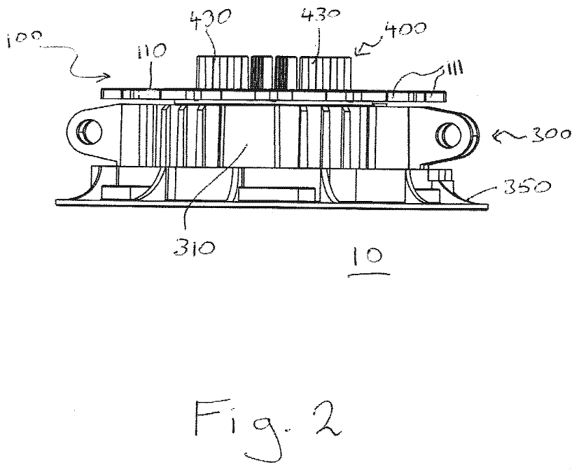

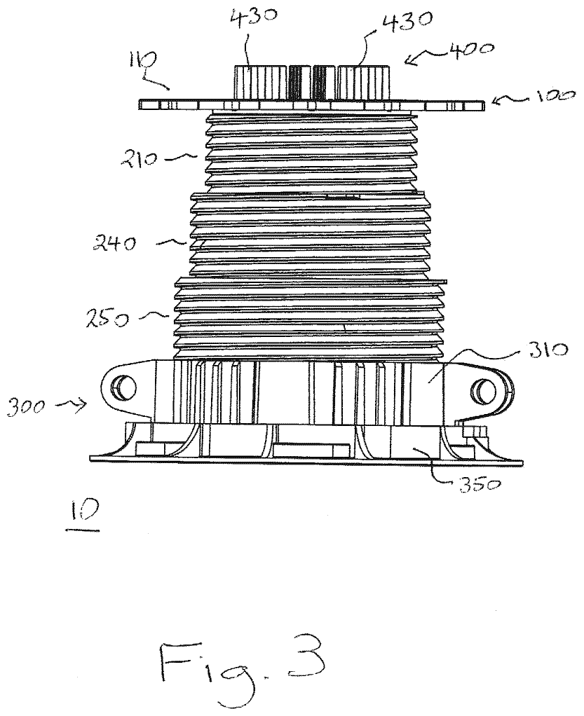

The pedestal assembly 10 can be adjusted so that its height can be configured between low (retracted) and high (extended) positions as shown in FIGS. 2 and 3, respectively. The telescopic members 210, 240 and 250 of the body 200 can be manipulated to adjust the overall height of the pedestal assembly 10. Specifically, the telescopic members 210, 240 and 250 are movable relative to each other preferably by screw-threaded rotation but they may also be slidably moveable relative to each other between an extended state and a retracted state, and rotatably movable with respect to one another to engage a locking mechanism (“twist-lock”) so that the vertical height of the pedestal assembly 10 can be quickly adjusted and locked by a user. To facilitate manual adjustment of the pedestal height, lugs 241 and 251 are located on the screw thread of telescopic members 240 and 250, respectively, for the user to rotate these members by hand.

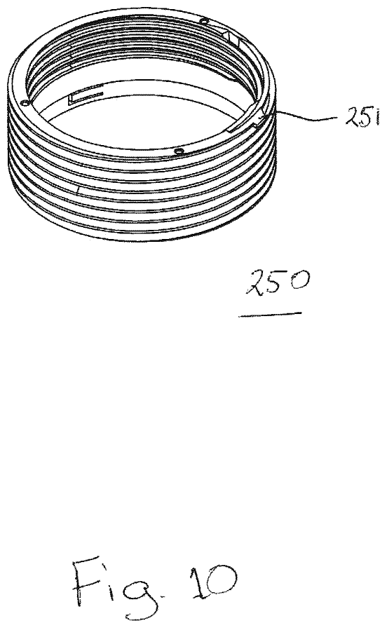

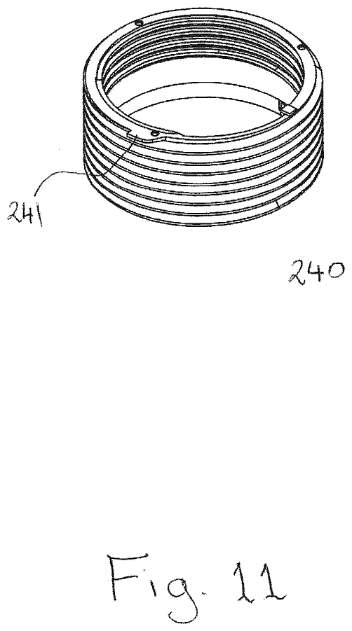

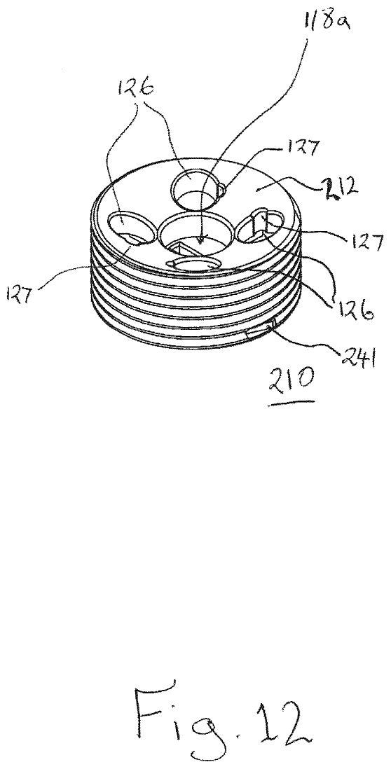

Referring now to FIGS. 1, 3 and 4, as well as individually in FIGS. 10, 11 and 12, the at least three telescopically arranged members 210, 240 and 250 of the body 200 are concentrically arranged tubular members, configured to be movable between an extended state, in which the members 210, 240 and 250 are extended relative to each other as shown in FIG. 3, and a retracted state, in which each of the telescopic members 210, 240 and 250 are at least partially received within the tubular housing 310 of the base 300. A fully retracted state is as shown in FIG. 2. It is to be appreciated that the meaning of “extended” should be interpreted to include configurations of the telescopic members when they are slightly or fully extended relative to each other and/or to the base housing 310. When fully extended, the first/top telescopic member 210 is positioned above the second/middle telescopic member 240 and the second/middle telescopic member 240 is positioned above the third/bottom telescopic member 250. In one configuration, the telescopic members 210, 240 and 250 are dimensioned such that the diameter of the top member 210 is smaller than that of mid member 240 and likewise its diameter is smaller than that of the bottom member 250 so that the top member 210 can be received within the two lower members, 240 and 250, in a retracted position. Each telescopic member 210, 240 and 250 is configured with a peripheral or outer thread adapted for operatively coupling with each lower member. The tubular housing 310 of the base 300 is configured with an internal threaded bore adapted for operatively coupling with the threaded member 250 of the body 200 to receive telescopic member 250 and, within that, members 240 and 210.

The telescopic members 210, 240 and 250 of the body 200 could account for a sizable portion of the overall height of the pedestal assembly 10, therefore positional adjustment to the telescopic members 210, 240 and 250 translates to vertical height adjustments of the assembly 10 during use. It is to be appreciated that, advantageously, adjusting the positions of the telescopic members 210, 240 and 250 with respect to each other and with respect to the base housing 310 by rotational movement provide a wide range of adjustable height increments for the pedestal assembly 10. In one configuration, the height of any one of the telescopic members 210, 240 and 250 may account for about 30% of the total adjustable height of the pedestal assembly 10. In another configuration, the height of any one of the telescopic members 210, 240 and 250 may account for about 25% of the total adjustable height of the pedestal assembly 10. In yet another configuration, the height of any one of the telescopic members 210, 240 and 250 may account for about 20% of the total adjustable height of the pedestal assembly 10.

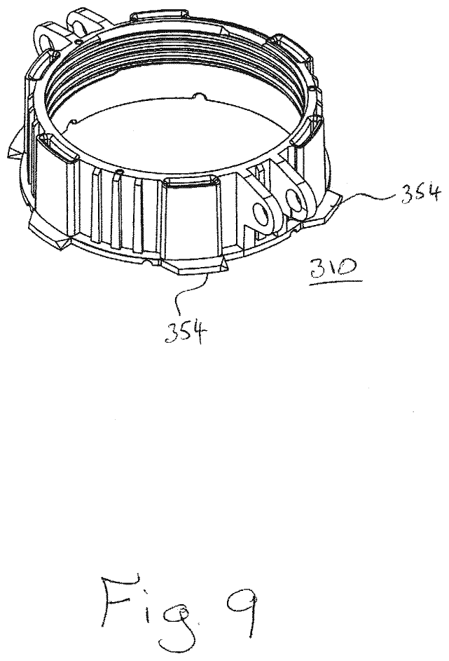

With reference to FIGS. 8 and 9, the tubular housing 310 of the base 300 includes detents 354 that engage with corresponding indents 352 having slotted extensions 353 of the base plate 350 to releasably connect these two components of the base 300 through rotation. This releasable functionality of the base allows for height extenders (not shown) to be added to the pedestal assembly between the base plate 350 and the tubular housing 310 when and where required by providing the height extenders with complimentary detents 354 and slotted indents 352 to increase pedestal heights up to about 1 m. As with other adjustments of the pedestal assembly 10, the addition of height extenders may be accomplished manually.

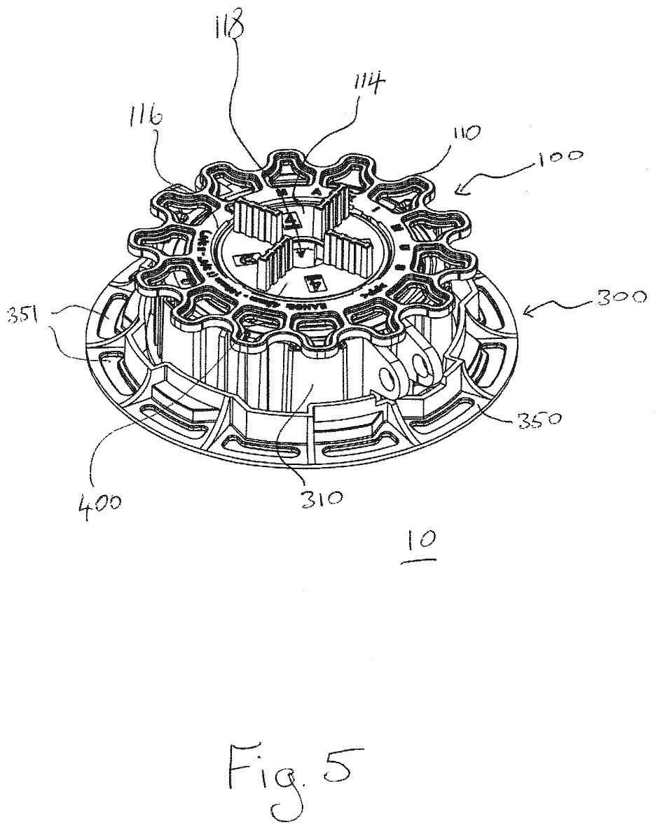

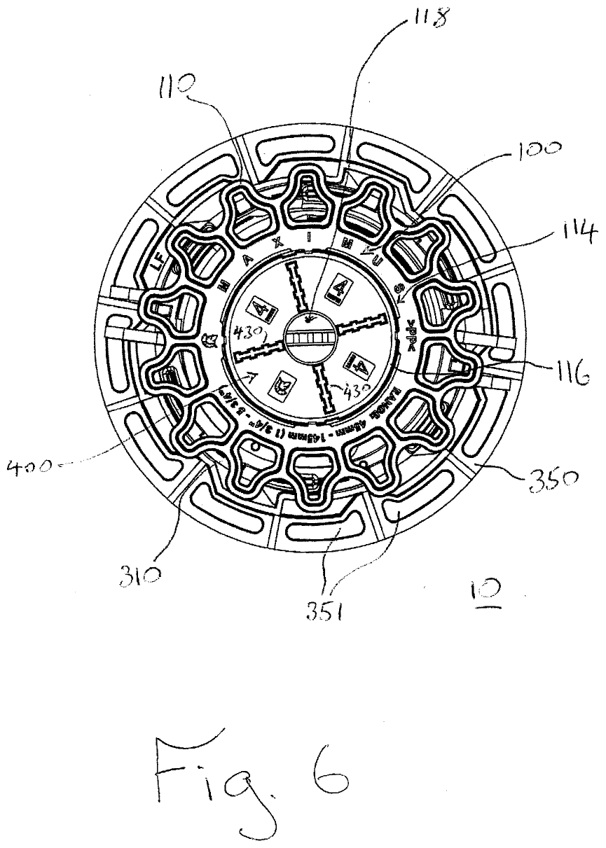

As best shown in FIGS. 1, 5, 6 and 13, the support member 100 comprises a surface plate 110 for supporting one or more flooring elements (not shown). A spacer 400 may be coupled to the support member 100, the spacer having substantially vertically extending projections 430 for providing a fixed gap between adjacent flooring elements supported by the surface plate 110 in use. The surface plate 110 has a first annular aperture 114 with means for operatively receiving the spacer 400. In one configuration, the first annular aperture 114 is provided with an inwardly projecting collar 116 extending around the circumference of the aperture 114 for seating the spacer 400 in a horizontal orientation. The projections 430 of the spacer 400 may be configured with a different thickness so that different sides of the spacer 400 can be used to accommodate gap requirements of different flooring elements. In one embodiment, the thickness of the projections 430 is about 3 mm. In another embodiment, the thickness of the projections 430 is about 5 mm. In some configurations, the projections 430 may be formed, in their horizontal sectional plane, in the shape of “W” to minimise material waste while maintaining structural strength.

The surface plate 110 may also be provided with additional apertures to further reduce materials used. Alternatively, the surface plate 110 may be provided with a honeycomb pattern arrangement to reduce materials used. In this respect, as with the embodiments shown in the drawings, the peripheral or outer circumference of the surface plate 110 has aperture formations that provide notches 111 extending therefrom or in between for assisting hand or finger engagement by the user for rotating the support member 100 and in turn the body 200 to adjust the height of the pedestal assembly 10 by an operative coupling of a levelling surface 120 of the support member with an engagement surface 212 of the first telescopic member 210 of the body 200, as explained below. Having the facility of rotating the telescopic members 210, 240 and 250 with rotation of the support member 100 by hand engagement with the outer peripheral notches 111 of the surface plate 110 provides another convenient mechanism for adjusting the pedestal assembly 10 in addition to rotation of the telescopic members 210, 240 and 250 by means of the lugs 241 and 251.

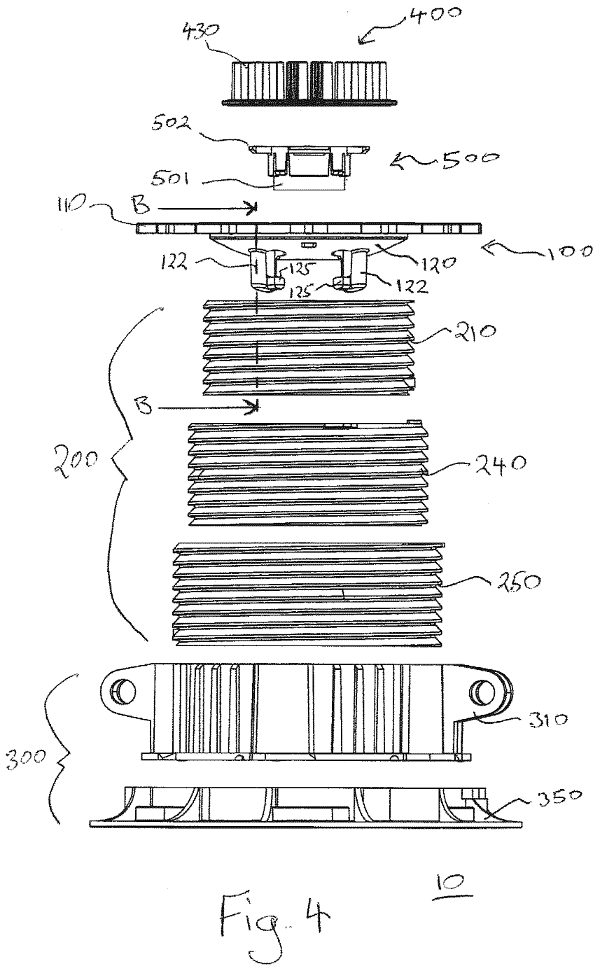

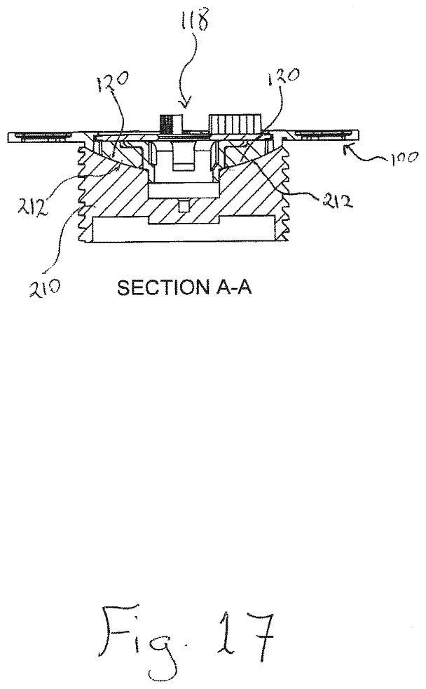

With reference to FIGS. 4, 14 and 17, in a preferred embodiment, the support member 100 comprises a non-planar or curved central levelling surface 120. The levelling surface 120 of the support member 100 has protrusions or formations 122 extending therefrom comprising substantially orthogonal abutments 125. The protrusions 122 are configured for operatively coupling the levelling surface 120 of the support member 100 with a corresponding but complimentary non-planar or curved engagement surface 212 of the uppermost telescopic member 210 of the body 200 when assembled, so that a tilt angle of the support member 100 can be adjusted by pivoting the support member 100 with respect to the body 200 to provide rotational movement of the levelling surface 120 with respect to the engagement surface 212. This arrangement provides adjustment to the tilt angle of the support member in a range of movement that is limited by a tolerance of the coupling of the protrusions 122 with receiving apertures 126 of the engagement surface 212, as explained further below.

In order to accomplish the operative coupling of the levelling surface 120 of the support member 100 with the engagement surface 212 of the telescopic member 210 and releasably engage the support member 100 with the body 200 of the pedestal, the protrusions 122 of the support member 100 are adapted to engage with corresponding apertures 126 located in the engagement surface 212. Furthermore, corresponding notches 127 at the periphery of the apertures 126 provide for a keying engagement with the orthogonal abutments 125 of the protrusions 122 to allow for releasable engagement of the support member 100 with the body 200. The corresponding apertures 126 are substantially larger in dimension than the protrusions 122 to allow for a range of pivotal movement of the support member 100 within the confines of the engagement surface 212. In preferred forms this pivotal movement will correspond to a range of +/−about 3° to about 7° from the horizontal plane of the top surface of the body 200. This tiltable range of movement of the support member 100 provides for ample compensation for variable slope in underlying ground, floor or substrate surfaces upon which the pedestal assembly 10 is to be placed.

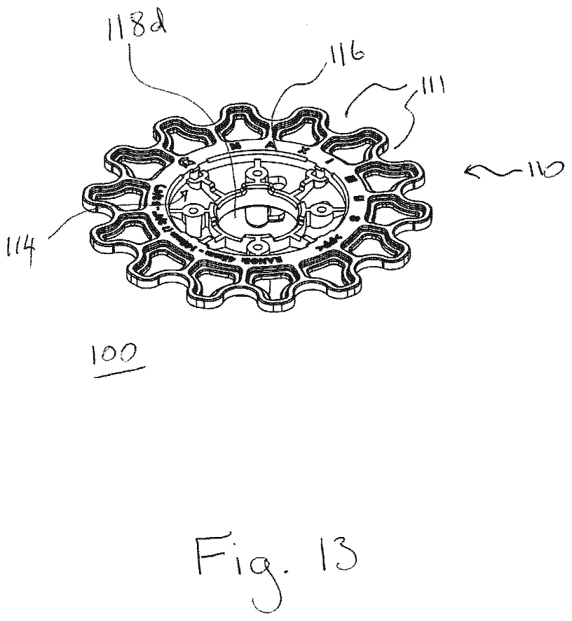

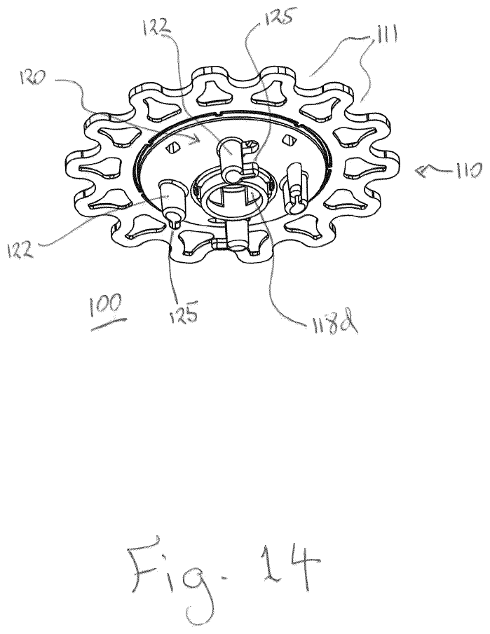

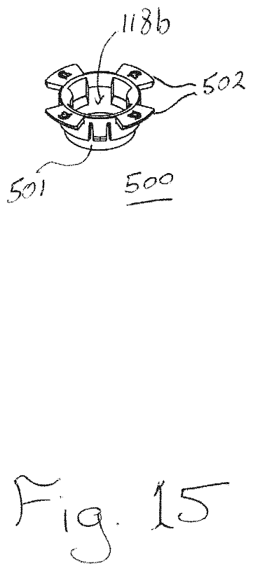

As first shown in the exploded view of FIG. 4 and with reference to FIG. 15, a locking component 500 is included for use with the pedestal assembly 10. The locking component 500 may be in the form of a locking ring or nut. Simply by placing the locking component 500 within a second central aperture 118d of the support member 100 (best shown in FIGS. 13 and 14), the support member, i.e., the surface plate, is fixed or locked into a position normal to the height (or axial direction) of the pedestal. This is equivalent to a position that is parallel with the base plate 350. The locking component 500 achieves the positional fixing of the support member with respect to the body 200 by having a collar 501 that penetrates through the aperture 118d of the support member 100 and also into a central aperture 118a of the telescopic member 210 where the collar is dimensioned to prevent relative movement of these two components when inserted in the commonly aligned apertures 118d and 118a. As would be appreciated by the person skilled in the art, biased formations on the collar and/or the walls of receiving apertures in the member 210 or support member 100 can provide frictional or interference engagement of the locking mechanism 500. A flange or flange portions 502 of the locking mechanism 500 act(s) to assist in seating the locking mechanism within at least the receiving aperture 118d of the support member 100.

Further to the locking functionality of the locking mechanism 500 acting in concert with the respective apertures 118d and 118a of the support member 100 and the first telescopic member 210, a commonly aligned aperture 118 is formed in the pedestal assembly 10 when all of the first telescopic member 210, the support member 100, the locking mechanism 500 and the spacer 400 are in situ. This commonly aligned aperture 118 is formed by the aperture 118a of the telescopic member 210, the aperture 118d of the support member 100 as well as an aperture 118b of the locking component 500 and a further aperture 118c located centrally in the spacer 400.

As such, the commonly aligned aperture 118 allows for ready access to a drive mesh 600 of the first telescopic member 210 by an appropriately configured tool (not shown) that, once engaged, allows for rotation of member 210 and hence adjustment of the height of the pedestal assembly, even when the pedestal assembly is in use with all components assembled and loaded with one or more construction elements (e.g., floor tiles). An appropriately configured tool may be in the form of a high speed chuck adapted for use with a powered drill or a maintenance key operated by hand. By virtue of the limited range of tilt adjustment described above for the support member 100, the drive mesh 600 of member 210 remains accessible to a tool for adjustment through the commonly aligned aperture 118.

In use, a plurality of pedestal assemblies 10 can be arranged in an array across a ground surface. The height of each pedestal assembly 10 can be adjusted manually or by use of the appropriate tool as described above. Accordingly, adjustments to each of the pedestal assembly heights can be made in accordance with a preferred embodiment by rotating the support member 100 and/or one or more of the telescopic members 240 or 250. Sloping angles of the ground can be offset adjusting the tilt of the supporting member 100. The above steps can be repeated for the plurality of pedestal assemblies 10 so that an appropriate elevated construction surface can be provided to support the mounting of, for example, flooring elements. Although the steps described above are provided in a specific order, it can be performed in any variation of this order and additional steps may be executed between the steps described above.

It is to be appreciated that preferred embodiments of the invention advantageously provide pedestal assemblies in which large height increments can be adjusted quickly and easily, thereby saving significant time and labour costs. Furthermore, preferred embodiments of the invention provide improved pedestal assemblies with a wide adjustable height range, as and shown in the accompanying Figures, which reduces the need for users to procure and install a variation of pedestal types and additional add-on components to the pedestal assemblies; potentially contributing to further cost savings.

In alternate embodiments, the present invention may be directed to a kit of parts for a pedestal assembly for levelling a construction surface and supporting at least one construction element, the kit of parts comprising:
a pedestal assembly base;
a pedestal assembly body that is operatively and releasably couplable to the base and comprises one or more telescopic body members, each body member operably connectable or coupleable to another respective body member;
a construction element support member having a non-planar levelling surface adapted for coupling to a complimentary non-planar engagement surface of at least one of the body members;
a pedestal assembly locking component for fixing the position of the construction element support member with respect to the pedestal assembly body; and,
a construction element spacer adapted to be accommodated by the support member for aligning one or more construction elements, where each of the above noted parts of the kit of parts is as disclosed herein.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, any means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.,” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.,” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

We claim:

1. A system for levelling a construction surface and supporting at least one construction element, the system comprising at least one pedestal assembly comprising:
a base for supporting the pedestal assembly on a substrate surface;
a body comprising a plurality of operably connected telescopic members, the body operatively and releasably coupled to the base;
a support member for supporting the at least one construction element, wherein the support member comprises a levelling surface adapted for coupling with a corresponding complimentary engagement surface of a first of the plurality of telescopic members of the body so that a tilt angle of the support member is adjusted by pivoting the support member with respect to the body;
a locking component adapted to be placed within a commonly aligned aperture of at least the support member and the first of the plurality of telescopic members, the locking component configured to fix the position of the support member with respect to the body;
a spacer adapted to be accommodated by the support member for aligning one or more construction elements;
wherein adjustment of the height of the pedestal assembly is facilitated by one or a combination of:
manual movement of the support member;
manual movement of at least one of a second or third telescopic member of the body, and;
tool engagement with a drive arrangement of the first telescopic member of the body accessible via a commonly aligned aperture of the first telescopic member of the body, the support member, the locking component and the spacer.

2. A system as claimed in claim 1 wherein the levelling surface of the support member and the complimentary engagement surface of the first telescopic member are non-planar or curved.

3. A system as claimed in claim 1, wherein each of the base, the plurality of operably connected telescopic members and the support member are operatively coupled to each other for adjusting the height of the pedestal assembly by relative rotational movement.

4. A system as claimed in claim 1, wherein the locking component is configured to fix the position of the support member to be parallel with the base.

5. A system as claimed in claim 1, wherein the manual movement of the support member and at least one of a second or third telescopic member of the body for adjusting the height of the pedestal assembly is rotational movement.

6. A system as claimed in claim 5 wherein the rotational movement is assisted by one or a combination of:
screw threaded configuration of the telescopic members;
the second or third telescopic members having lugs for assisting hand or finger engagement by a user, and;
peripheral aperture formations of a support plate of the support member that provide notches for assisting hand or finger engagement by a user.

7. A system as claimed in claim 1, wherein the base comprises a housing and a base plate that are releasably connectable for insertion of height extenders.

8. A system as claimed in claim 1, wherein the drive arrangement of the first telescopic member is a mesh drive.

9. A pedestal assembly for levelling a construction surface and supporting at least one construction element, the pedestal assembly comprising:
a base for supporting the pedestal assembly on a substrate surface;
a body comprising a plurality of operably connected telescopic members, the body operatively and releasably coupled to the base;
a support member for supporting the at least one construction element, wherein the support member comprises a levelling surface adapted for coupling with a corresponding complimentary engagement surface of a first of the plurality of telescopic members of the body so that a tilt angle of the support member is adjusted by pivoting the support member with respect to the body;
a locking component adapted to be placed within a commonly aligned aperture of at least the support member and the first of the plurality of telescopic members, the locking component configured to fix the position of the support member with respect to the body;
a spacer adapted to be accommodated by the support member for aligning one or more construction elements;
wherein adjustment of the height of the pedestal assembly is facilitated by one or a combination of:
manual movement of the support member;
manual movement of at least one of a second or third telescopic member of the body, and;
tool engagement with a drive arrangement of the first telescopic member of the body accessible via a commonly aligned aperture of the first telescopic member of the body, the support member, the locking component and the spacer.

10. A kit of parts for a pedestal assembly for levelling a construction surface and supporting at least one construction element, the kit of parts comprising:
a pedestal assembly base;
a pedestal assembly body that is operatively and releasably couplable to the base and comprises one or more telescopic body members, each body member operably connectable or coupleable to another respective body member;
a construction element support member having a non-planar levelling surface adapted for coupling to a complimentary non-planar engagement surface of at least one of the body members;
a pedestal assembly locking component for fixing the position of the construction element support member with respect to the pedestal assembly body; and,
a construction element spacer adapted to be accommodated by the support member for aligning one or more construction elements,
